(19) United States
(12) Patent Application Publication
(10) Pub. No.: US 2014/0127477 A1
(43) Pub. Date: May 8, 2014

(54) SYSTEMS AND METHODS FOR CONVEYANCE OF A SUBSTANCE INTO A HETEROGENEOUS MATERIAL

(71) Applicant: William Douglas Grier, II, Rancho Cucamonga, CA (US)

(72) Inventor: William Douglas Grier, II, Rancho Cucamonga, CA (US)

(21) Appl. No.: 14/075,683

(22) Filed: Nov. 8, 2013

Related U.S. Application Data
(60) Provisional application No. 61/796,346, filed on Nov. 8, 2012.

(51) Int. Cl. B05D 5/06

(52) U.S. Cl. CPC B05D 5/06
USPC 428/195.1; 427/554

(57) ABSTRACT

Systems and methods are described in which composite solids such as dyed fibers or fabrics are produced by reversibly generating permeable regions within a heterogeneous solid. Permeating substances are trapped within the heterogeneous solid on reversal of the permeability to form a composite solid, within which the permeating substances are protected from environmental factors.

This application claims priority to U.S. provisional application having Ser. No. 61/796,346 filed on Nov. 8, 2012. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is textile printing and dyeing, specifically printing and dyeing of synthetic polymer fibers.

### BACKGROUND

The following description includes information that may be useful in understanding the present invention. It is not an admission that any of the information provided herein is prior art or relevant to the presently claimed invention, or that any publication specifically or implicitly referenced is prior art.

Historically the decoration and dyeing of textiles has been accomplished using chemical reactions and compounds for the basis of color. For thousands of years this process has used water as the carrier of these chemicals. In the mid 20th century, synthetic polymer fibers such as nylon and polyester were introduced that proved to be difficult to dye, resulting in the addition active chemicals and catalysts to the solutions carrying the dyes. These dyes and chemicals often find their way to lakes, rivers, and oceans, and cause serious environmental damage. Traditional dyeing utilizes large amounts of fresh water, ranging from about 56 to 600 times the weight of the fabric. Because of the large amount of water typically required, the textile industry consumes an unsustainable 2.4 trillion gallons of water per year throughout the world.

Fabrics made from synthetic polymers pose particular challenges to dyeing. Unlike natural fibers, these materials are frequently a heterogeneous mixture of different solid phases (for example, crystalline, semi-crystalline, and amorphous phases) that accept dye compounds to different extents, and colorfastness after dyeing can be poor. Attempts have been made to address this issue. For example, U.S. Pat. No. 6,544,300 (to Cliver and Williams) discloses a method for treating synthetic polymer fibers at high temperatures (>400° C.) to increase the relative amount of a relatively easily dyed amorphous phase. This treatment, however, also increased the amount of a non-dyeable crystalline phase and the resulting product tended to shed dye when heated.

Other approaches utilize synthetic polymer fibers with composition intended to improve dye acceptance. For example, Untied States Patent Application No. 2005/0,217,037 (to Negola) discloses the addition of “dye enhancers” such as glycol-modified monomers to polyolefin fibers. The dye enhancer component of the fibers accepts dye more easily than the polyolefin alone, however the inventors note that additional compounds often need to be added to give good dispersion of the dye enhancer groups and improve color leveling. A similar approach is described in Untied States Patent Application No. 2010/0,035,497 (to Slerakowski, Cleenewerk, and Prufe), which discloses the addition of polypropylene monomers that carry dicarboxylic acid groups to the formulation of polypropylene fibers in order to adjust the glass transition temperature of the composite polymer. The resulting fiber is dyed by the addition of colorant at an elevated temperature that is above the glass transition temperature but below the melt point of the material. Such modified polymers, however, require more complex manufacturing processes, and the effects of the modified polymer formulations on resistance to wear and chemical stability are not clear.

Thus, there remains a need for a process that can efficiently infiltrate colorants and other substances into synthetic polymer fibers and other heterogeneous materials.

### SUMMARY OF THE INVENTION

The inventive subject matter provides apparatus, systems and methods in which a dye or other substance(s) is infiltrated into a heterogeneous solid that comprises at least two solid phases, for example a synthetic polymer fiber. Dye or other substances that a user desires to infiltrate into the heterogeneous solid are introduced to the solid to be infiltrated. Energy (for example heat and/or electromagnetic energy) is applied at or around a characterized Boson peak region of the heterogeneous solid, resulting in an increase in the permeability of an interface region between the two solid phases (e.g., amorphous and crystalline) to the dye or other substance. In some embodiments this energy is applied at reduced (i.e. less than 1 atmosphere) pressure. The increase in permeability is due to the temporary formation of tunnels or similar structures within the interface region due to the amount of energy applied. The infiltrating material is driven into the permeabilized interface region by diffusion, capillary forces, ripplons, or a combination of these or similar forces. Following uptake of the dye or other material the energy applied to the heterogeneous solid is changed, resulting in a reduction the permeability of the interface region, trapping the dye or other material within the heterogeneous solid and can result in dispersion of the dye or other material within the heterogeneous solid.

One group of embodiments of the inventive concept are methods for infiltrating a substance into a heterogeneous solid, for example a synthetic polymer or a fiber. The heterogeneous solid includes a first phase, a second phase, and an interface region that is interposed or lies between the first and second phases. In some embodiments the first region includes an amorphous solid and the second region includes a semi-crystalline or crystalline solid. A permeating substance, for example a dye or other colorant or other material, is brought into contact with the heterogeneous solid and an energy is applied. Energy may be applied before or after the substance or other material is brought into contact with the heterogeneous solid. The applied energy causes the interface region to become permeable in a temporary or reversible fashion, for example by the formation of tunnels. This is accomplished by applying an energy that preferably lies within a Boson peak region of the material of the heterogeneous solid. Such energy can be in the form of heat, electromagnetic radiation (for example infrared radiation), or a combination of these. In some embodiments the energy is applied in at least a partial vacuum to advantageously reduce the temperature required to cause permeability of the interface region thereby allowing for lower temperatures and expanding the range of heterogeneous materials that could be used in the methods described herein. A driving force is applied that infiltrates the permeating substance into the interface region. Suitable driving forces include capillary action and/or the formation of ripplons. The applied energy is then modified to reduce the permeability of the interface region or, alternatively, render it impermeable.

Another group of embodiments of the inventive concept are composite solids made by infiltrating a permeating substance, for example a dye or other colorant, into a heterogeneous solid, for example a synthetic polymer or fiber. The heterogeneous solid has multiple solid phases, including a first region, a second region, and an interface region between the first and second regions. The permeating substance is introduced into the interface region of the heterogeneous solid by application of an energy that renders the interface region temporarily or reversibly permeable, for example by applying an energy that is at a Boson peak region of the heterogeneous solid. In some embodiments the first region is an amorphous solid and the second region is semi-crystalline or crystalline solid. In a preferred embodiment the composite solid is resistant to chemical bleaching.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 shows a nonlinear increase in specific heat as temperature is raised in an amorphous solid, demonstrating a Boson peak region characteristic of such materials.

FIG. 2 schematically depicts a heterogeneous solid, having an amorphous phase, an semi-crystalline or crystalline phase, and an interface region where the two phases meet.

FIG. 3 schematically depicts an initial phase of the infiltration process, where a material to be incorporated into the heterogeneous solid is placed in contact with the surface of the heterogeneous solid.

FIG. 4 schematically depicts the application of energy to the heterogeneous solid, resulting in increased permeability as shown by the formation of tunnels.

FIG. 5 schematically depicts movement of the applied material into the interior of the heterogeneous solid via the permeabilized regions.

FIG. 6 schematically depicts sealing of the incorporated material within the heterogeneous solid and partial reversal of permeabilization on changing the applied energy.

FIG. 7 schematically depicts dispersal of the incorporated material within the heterogeneous solid to produce a composite solid.

FIG. 8 depicts one embodiment of a system that allows dispersion of a substance within a material.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The inventive subject matter provides apparatus, systems and methods in which a dye or other substances is infiltrated into a heterogeneous solid that is a mixture of at least two solid phases, for example a synthetic polymer fiber. Apparatus, systems, and methods of the inventive concept utilize application of energy that lies within or near a Boson peak of the material of the heterogeneous solid to temporarily and/or reversibly permeabilize the material, permitting infiltration and subsequent dispersal of dyes, colorants, and/or other substances within the body of the heterogeneous solid.

As disclosed, systems, methods, and processes of the inventive concept utilize a unique combination of energy emission and transmission environments to multiply the energy efficiency and control needed to produce permanent repeatable infiltration of coloration or other substances into fabrics and other materials. The inventor has identified a novel phenomena, in which penetration or infiltration of substances into heterogeneous solids that include an amorphous component can be realized by energizing the solid (for example, via heat and/or infrared/near infrared irradiation) to where the solid approaches or reaches a Boson peak characteristic of an amorphous phase of the solid. Altering conditions and/or energy inputs to move away from the Boson peak conditions reverses changes in the permeability of the solid and entraps the infiltrating substance within the solid. For example, the transition of the solid back to a non-permeable state advantageously allows for dyes to be trapped deeper within the solid than with prior art dyeing methods, and thereby helps the solid maintain the dyed color despite exposure to ultraviolet radiation or bleach, as just two possible advantages. Surprisingly, the inventor has found that altering the environment within which the energy is applied (i.e. the transmission environment), for example by reducing the ambient air pressure, permits phase transitions characteristic of the process to occur at reduced temperatures.

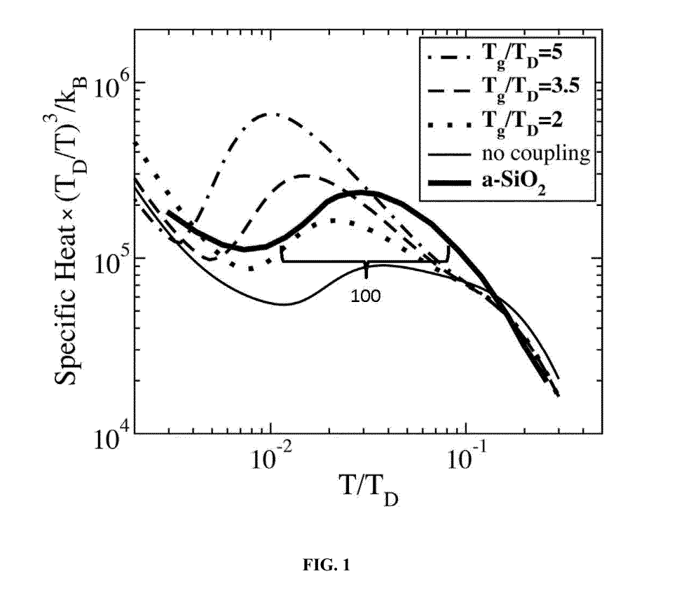

Without wishing to be bound by theory, the inventor believes that this phenomena may be related to the behavior of materials as described by Lunkenheimer and Loidl (J. Non-Cryst. Solids (2006) 352:4556-4559) and Lubchenko and Wolynes (Proc. Nat. Acad. Sci. (2002) 100(4):1515-1518), who postulated that the Boson peak may be related to local changes within the material, which may result from the mosaic structure of glasses and other amorphous solids that results from their method of preparation. A Boson peak can be readily observed in suitable materials, such as amorphous polymers, by techniques that characterize parameters dependent on the number of degrees of freedom available to atoms or molecules within the material. Typical techniques include microcalorimetric determination of heat capacity, neutron scattering, and electromagnetic radiation scattering. A typical Boson peak for amorphous silica 100 is shown in FIG. 1, taken from Lubchenko and Loidl, which shows changes in heat capacity as a function of temperature (shown as a ratio to the Debye temperature for silica). The resulting nonequilibrium may manifest as stored energy in the form of stress at the boundaries between amorphous and crystalline clusters within the structure of a polymer or other heterogeneous solid, and can act as a source of mechanical action that provides space and capillary action to load a dye, colorant, or other desired substance into heterogeneous solid, such as a synthetic fiber.

The conversion of the intrinsic energy stored during formation of the heterogeneous solid into mechanical excitation, which forms tunnels and the accompanying capillary action (for example via a capillary tension wave, i.e. a ripplon) reaches its maximum efficiency at an energy return level at or near a Boson peak (e.g., within a Boson peak region) of the heterogeneous solid. Surprisingly, the inventor has found that by maintaining a receiving heterogeneous solid (for example a fiber) at an energy level corresponding to a Boson peak region of the solid after melting a donor or permeating substance on the surface of the heterogeneous solid, the permeating substance can be pumped into the heterogeneous solid without the use of a solvent carrier or activating chemicals. In a preferred embodiment, such a process can be used for the introduction of dyes or other colorants to fibers and fabrics while removing the requirement for any use of water and toxic chemicals.

The equipment that produces the finished product can use electromagnetic energy and/or thermal energy sources. In some embodiments a high-energy placement stage uses banks of near infrared emitters (for example, filtered incandescent lights, light emitting diodes, or lasers) tuned to a resonance of the permeating substance (for example, a dye) and the heterogeneous solid (for example, a fiber). Such resonances can be readily identified using known techniques, such as IR and near IR spectroscopy. This allows rapid high volume placement of the permeating substance onto the heterogeneous solid. Placement techniques can be adapted to the nature of the permeating substance and the heterogeneous solid, and can include deposition of a solution or suspension of the permeating substance (for example via spraying, immersion, or printing), a phase change to convert the permeating substance (for example, a dye) to vapor which, then, condenses to liquid on the surface of the heterogeneous solid (for example, a fabric), or deposition of a dry permeating substance onto the surface of the heterogeneous solid (for example, by electrostatic attraction). It should be appreciated that the permeating substance can be applied to all or only a portion of the heterogeneous solid. Similarly, it should be appreciated that energy that permits the permeating substance to enter the heterogeneous solid can be applied to all of only a portion of the heterogeneous solid.

Once the permeating substance has been transferred to the surface of the heterogeneous solid (for example, a fabric), and is brought to a calculated energy level a physical phenomenon occurs magnifying the kinetic movement of the amorphous portion of the fibers' structure. Since all polymers both natural and manmade contain both crystalline and amorphous molecular structure the movement creates temporary regions of increased permeability, such as tunnels at the boundaries or interfaces between amorphous and crystalline or semi-crystalline regions. Such tunnels can support the formation of ripplons (capillary action surface waves) within the boundary or interface regions. Such ripplons can convey the permeating substance from the surface of the heterogeneous solid; in the introduction of dyes into synthetic fibers this can provide color penetration and leveling throughout the fiber. The amount and degree of penetration of a permeating substance can be controlled by adjusting emitter intensity, chamber air pressure, emission time, and/or the size of the permeating species. When the output of the energy source is reduced or eliminated the tunnels collapse, leaving the permeating material trapped below the surface of the heterogeneous solid. This advantageously protects the permeating substance from environmental factors. For example, dye introduced into a synthetic fiber or fabric in this fashion is impervious to bleach and other cleaning agents.

The three defining steps of the infusion of a permeating substance into a heterogeneous solid using such active tunnel processes are placement, penetration and leveling. The following is a detailed description of each step for an exemplary process in which a dye or colorant is introduced into a synthetic fiber.

Placement:

A typical colorant used in this process is an inert dispersed dye, however, the process is not limited to such colorants. Rather the process could utilize other liquids or solids for example, including pharmaceuticals and so forth. The placement of dye on the surface of the receiving heterogeneous solid, hereafter called the receiver, can be accomplished by a number of different methods. One of these is physical placement, for example printing directly on the surface of the receiver. Another method is to print the image on a donor paper and place it in contact with the receiver. A thermal or heating step changes the printed dye into a vapor, which diffuses to the surface of the receiver and condenses into an image or color on the surface of the receiver. This process has been used historically as a final coloring solution. Another method of placement that can be used when the desired end product is a solid color is to place the receiver in a microcoating device and roll or spread a dye solution evenly on the surface receiving surface, then store for later use. Still another method is to attract the dye to the surface of the receiver using electrostatic interactions. This method is particularly advantageous in reduced pressure environments. It should be appreciated, however, that any method that brings the dye (or any desired permeating substance) into contact with the surface of the heterogeneous solid receiver can be suitable. Once the dye is in position on the surface of the receiver the receiver is ready for the next process step.

Penetration:

Once the dye has been placed on the surface of the receiver the condensed liquid is conveyed into gaps or tunnels formed at the boundary or interface region between crystalline and amorphous phase zones in the receiving material. Tunnels are formed in the receiver by the application of controlled energy at or around a Boson peak of the receiving material (e.g., with a Boson peak region). Without wishing to be bound by theory, the inventor believes that this is accomplished by exciting the enthalpies of formation (energy stored during formation) of the polymer or other heterogeneous material using thermal energy and/or harmonically tuned photons (light waves). It is believed that the observed increase in degrees of freedom within the amorphous phase of the receiver within the Boson peak region is derived, at least in part, from orbital movement of amorphous phase zone molecular clusters, which in turn induce the formation of gaps or tunnels that permeabilize the interface region between the stationary crystalline cluster and the excited orbiting amorphous clusters. These gaps or tunnels extend deep into the interior of the receiving heterogeneous solid. The surface of the tunnel walls can exhibit capillary forces, for example, a wave of capillary surface action (i.e. ripplons) away from the energy source, which conveys the dye or other permeating substance deep into the heterogeneous solid.

Leveling:

The energy applied to the receiving heterogeneous solid is maintained at a level at or around a Boson Peak of the receiver (e.g., within a Boson peak region) until all excess dye has been drained from the surface and deposited into the body of the receiver. While this provides efficient delivery of the permeating substance into the interior of the heterogeneous solid, the permeating substance can still be largely confined to the gaps or tunnels induced in the permeabilized interface regions. In order to produce a more evenly infiltrated composite product it is desirable to redistribute the dye or other permeating material within the heterogeneous solid. This can be accomplished by slowly reducing the applied energy, causing the boundary crevices to close on the dye clusters. This vice-like collapse of the tunnels creates mechanical stress on the dye clusters, causing them to decompose to smaller parcels and further disperse and saturate the receiver, thus leveling the distribution of the dye and the appearance of the color. On further reduction or termination of the input energy, the tunnels fully collapse, which leaves the dye permanently trapped inside the receiving polymer.

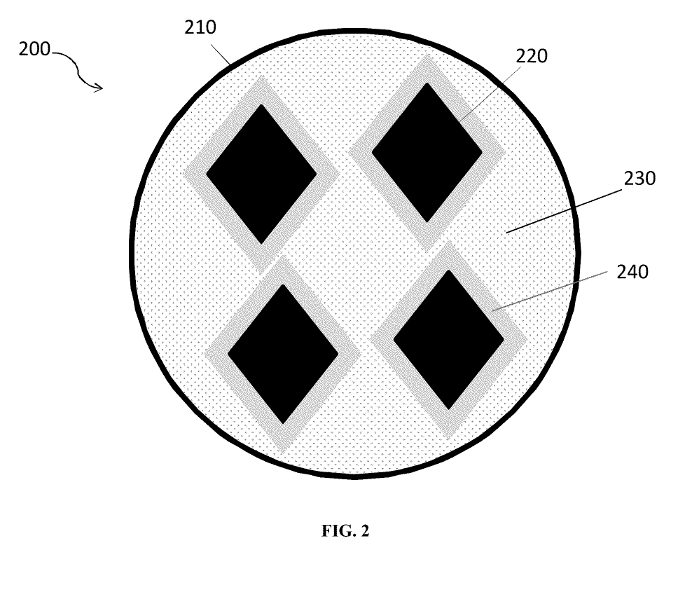

FIG. 2 through FIG. 7 illustrate the steps of a process of the inventive concept. FIG. 2 shows a heterogeneous solid 200 with a surface 210. In some embodiments the heterogeneous solid is made of a single material that is arranged in different fashions throughout the solid, for example a solid made of a polymer that has solidified in different molecular configurations. In other embodiments the heterogeneous solid can include different materials or types of materials. In a preferred embodiment the heterogeneous solid is a synthetic fiber, which can be treated as an individual fiber, as part of a yarn, as part of a felt or woven fabric, or as part of a finished textile good (or a portion thereof). The heterogeneous solid 200 includes two or more solid phases, for example a crystalline or semi-crystalline phase 220 and an amorphous phase 230. The different phases can have different permeabilities. An interface region 240 occurs where the different phases interact.

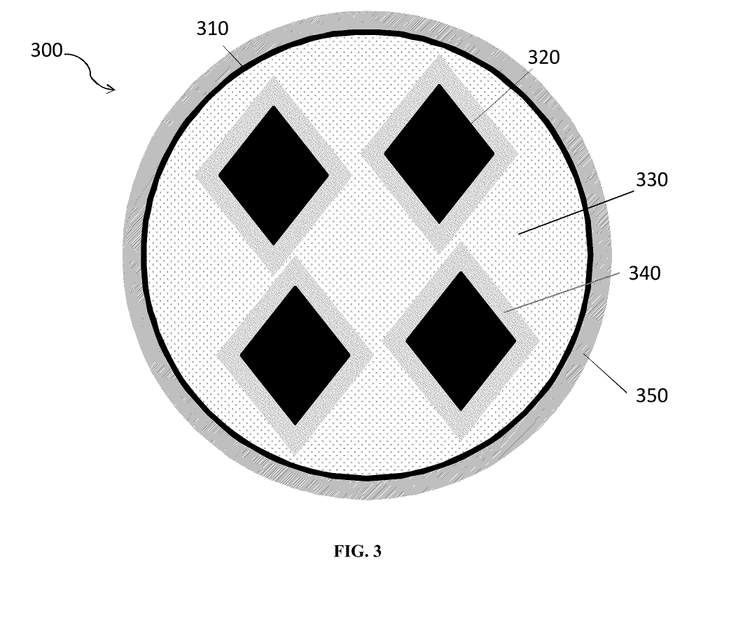

FIG. 3 shows the heterogeneous solid that has been contacted with a permeating substance 300 that a user wishes to infiltrate into the heterogeneous solid. As depicted here, the permeating substance 350 is applied to the surface 310 of the heterogeneous solid, and at this point in the process does not contact the crystalline or semi-crystalline phase 320, the amorphous phase 330 or the interface region 340 except where such phases or regions form part of the surface 310. The permeating substance 350 can be applied to the surface 310 by any suitable means, for example direct application (ex: as a solution, suspension, paste, or powder), transfer (ex: heat transfer from a transfer sheet), electrostatic attraction between oppositely charged permeating substance and heterogeneous solid, or any means that provides physical contact between the permeating substance 350 and the surface 3210 of the heterogeneous solid without resulting in significant damage or loss of desired activity or characteristics. Although depicted as covering the heterogeneous solid 300, it should be appreciated that the permeating substance 350 can be applied to only a portion of the heterogeneous solid 300.

The nature of the permeating substance 350 depends on the intended properties with which the user intends to endow the final composite material. Examples of permeating substances include dyes or other colorants (such as fabric dyes and pigments), pharmaceutically active substances (such as steroid hormones, estrogens, androgens, acetylcholinesterase inhibitors, stimulants, antidepressants, insulin or insulin analogs, vitamins, nicotine, scopolamine, and/or analogs thereof), polymers with advantageous properties (such as polymers with high wear resistance, high chemical resistance, high tensile strength, a high refractive index, a low refractive index, and/or polymers capable of reflecting or absorbing non-visible wavelengths of electromagnetic energy), and/or metals or suspensions of metallic particles. In a preferred embodiment of the inventive concept the permeating substance 350 is a dye or other colorant suitable for use in textiles.

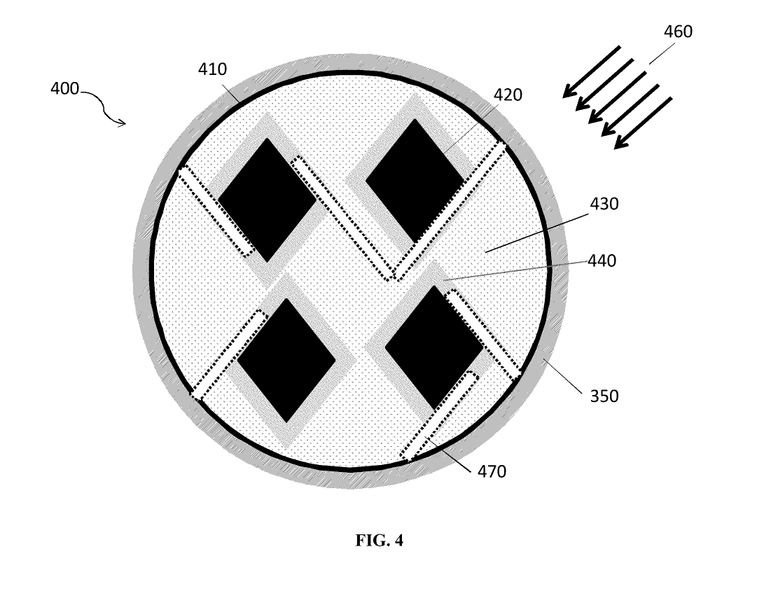

FIG. 4 depicts the formation of permeable regions within the coated heterogeneous solid 400. Energy 460 is applied to the coated heterogeneous solid 400 to cause the formation of permeable regions (for example, tunnels) 470 within the interface region 440 between the crystalline or semi-crystalline phase 420 and amorphous phase 430 regions of the heterogeneous solid. At least some of these permeable regions 470 extend to the surface 410 of the heterogeneous solid and can permit passage of the permeating substance 450. Surprisingly, the inventor has found that applying an energy that lies within a Boson peak region of the material of heterogeneous substance greatly facilitates the formation of the permeable regions or tunnels within the heterogeneous solid. Without wishing to be bound by theory, the inventor proposes that the use of such energy supports a large number of degrees of freedom within the amorphous phase 430 of the heterogeneous solid, thereby changing its fluidity and releasing tensions that develop during the formation of the heterogeneous solid. Without wishing to be bound by theory, the inventor believes that this tension is relieved by the formation of tunnels 470 or cracks within the interface regions 440 between the now more fluidic amorphous phase 430 and the relatively rigid crystalline or semi-crystalline phase.

The energy 460 applied to the heterogeneous solid 400 can be in any form suitable to apply the energy needed to drive the process in a controlled manner. Examples of suitable energies include heat (such as conductive heat and/or convective heat), electromagnetic radiation (for example, microwave, infrared, near infrared, visible, near ultraviolet, and/or ultraviolet radiation), electromagnetic induction, and/or chemical reaction. In a preferred embodiment of the inventive concept the energy is applied as heat, infrared or near infrared radiation, or a combination of these.

Surprisingly, the inventor has found that reducing atmospheric pressure (such as through the use of a vacuum or a partial vacuum) during energy application reduces the amount of energy required by the process. This advantageously reduces operating costs in terms of energy and equipment, and additionally can permit the use combination of materials that would be incompatible at ambient or elevated pressures. For example, selection of a suitable reduced pressure in combination with a suitable energy can permit the use of a permeating substance (for example a dye or colorant) with a melting point that is markedly different from that of the heterogeneous solid (for example a synthetic fiber). Such reduced pressures or at least partial vacuums can be applied by reducing ambient pressure within an enclosed space housing equipment used in the process or can be applied by reducing pressure within equipment used in the process (for example, in partially or transiently open equipment that permits continuous processing).

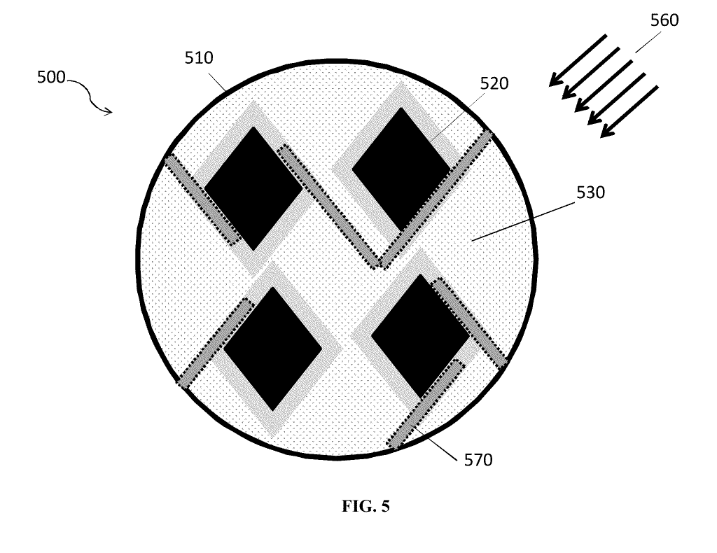

As shown in FIG. 5, application of the energy 560 results in an infiltrated heterogeneous solid 500. As in the depicted embodiment, the permeating substance can enter the permeabilized regions or tunnels 570 as the energy 560 is applied. In some embodiments of the inventive concept the permeating substance can be found primarily within the permeabilized regions or tunnels 570, being essentially entirely withdrawn from the surface 510 and not found in significant amounts within the bulk of the amorphous 530 and crystalline or semicrystalline 520 regions of the heterogeneous solid 500. Advantageously, the amount of permeating substance applied can be selected to be completely or nearly completely taken up by the heterogeneous solid 500, reducing or eliminating the need for post-treatment washing to remove unincorporated permeating substance. In a preferred embodiment the permeating substance is a dye or other colorant that is completely or nearly completely taken up by a synthetic fiber, thereby dramatically reducing the time required and the energy and water consumed by a dyeing or coloring process. Another advantage is realized in such embodiments in restricting the permeating substance to the interior of the final composite material, in that such placement provides protection from environmental factors (such as moisture, heat, chemicals, bacteria, fungi, and so on) that may degrade the permeating substance. In a preferred embodiment of the inventive concept localization of dyes or other colorants to the interior of a synthetic fiber provides protection from chemical oxidants (such as bleach), permitting disinfection during laundering of fabrics treated by such a process.

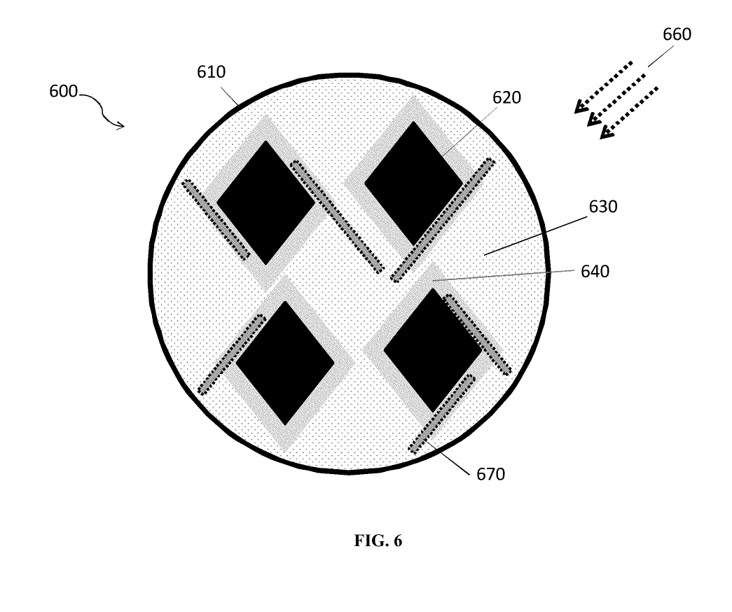

As shown in FIG. 6, the applied energy can be changed to seal the infiltrated heterogeneous solid 600. Changing the applied energy 660 (for example, reducing the energy applied to the heterogeneous solid 600) can result in at least a partial reversal of the changes in earlier steps, leading to an at least partial reduction of the permeabilized regions 670 (for example, an at least partial collapse of the tunnels). In some embodiments this collapse seals the incorporated permeating substance from the surface 610 of the heterogeneous fiber. This can place strain on the permeabilized regions 670 and the incorporated permeating material. In this process the permeating material can enter the bulk of the amorphous phase 630, but can remain separate from the crystalline or semi-crystalline phase.

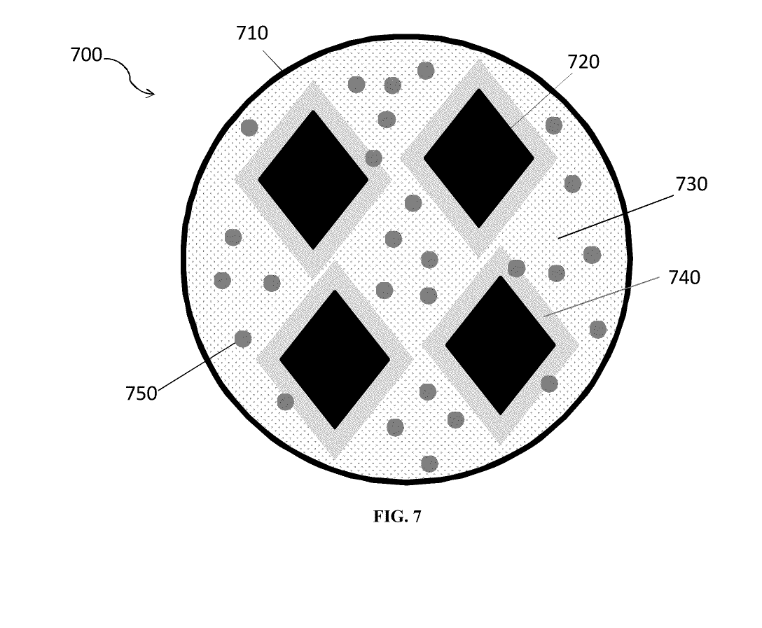

FIG. 7 depicts the infiltrated heterogeneous solid following the application of the energy. The permeating substance 750 is dispersed within the amorphous phase 730 by the stress induced by the reduction in permeability of the interface region 740 (for example, due to the collapse of tunnels). While permeating substance can be found in the interface region 740 it does not enter the crystalline or semi-crystalline phase 720. In preferred embodiments of the inventive concept application of the permeating substance is controlled such that essentially all of the permeating substance is incorporated into the heterogeneous solid to form a composite solid or substance 700, leaving little or no permeating substance on the surface 710. The resulting composite 700 advantageously provides a solid with the desired optical, pharmaceutical or other properties of the permeating substance while providing the environmental, chemical, and biological resistance of the heterogeneous solid.

During the development of this invention a number specific conditions and specific applications not disclosed or suggested in the prior art were discovered. These include the following:

Photons—

The use of frequency resonance as a method of material identification using Fourier transform infrared spectroscopy (FTIR) devices is an established practice. Surprisingly, the inventor has found that such resonant frequencies are useful to stimulate the uptake of permeating substances (such as dyes) into heterogeneous solids (such as fibers). Using electromagnetic energy (such as near infrared photons) to stimulate the enthalpies of formation of the dye and the receiver in separate emissions allows rapid activation in depth of both the dye and the receiver, and reduces the time required to infiltrate a dye into a receiver fiber or fabric to less than 10% of the time required when using radiated thermal energy. In some embodiments of the inventive concept the time required to infiltrate dye into a receiver fiber or fabric using electromagnetic energy or photons is equal to or less than about 5% of the time required when using radiated thermal energy.

Reduced Pressure—

Surprisingly, the inventor has discovered that air pressure inhibits the phase change of dye and the formation of tunnels in the receiving heterogeneous solid. Reducing air pressure through the formation of a vacuum environment during a coloration process substantially improves the efficiency of the energy source. Using thermal tests the inventor has found that the tri-point for phase change is reduced by about 7° C. for every 10% (kPa/kPa) reduction in air pressure. This advantageously permits the use of lower energy emitters and the activation of inert dyes previously thought to require too much energy for polymer coloration. Use of reduced pressures also supports the use of electrostatic interactions in coating processes. Pressure can be reduced during steps of the inventive process to about 90%, about 80%, about 70%, about 60%, about 50%, about 40%, about 30%, about 20%, about 15%, about 10%, about 5%, about 2%, about 1%, about 0.1%, about 0.01% or to less than about 0.01% of ambient air pressure.

Electrostatic Attraction—

Under certain conditions dyes and other permeating materials can be introduced to the receiving heterogeneous solid by vaporizing micro-particles in a reduced atmospheric pressure chamber and attracting them to an opposing charge in the dielectric receiver. This process has particular utility for permeating substances that may not tolerate more traditional transfer processes, such as pharmaceutical compounds, biomolecules (such as proteins and nucleic acids), and polymers.

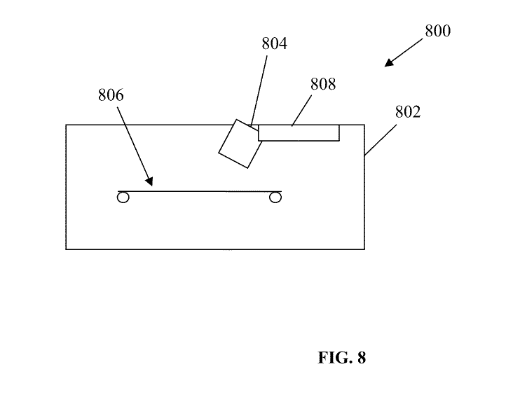

FIG. 8 illustrates one embodiment of a system 800 for applying a substance to a material 806. Preferred systems can include a device 802 configured to receive the material 806. It is contemplated that material can be passed through the device 802 such as via rollers or other means. In other embodiment, material can be received via an automated system such as a mechanical arm that presents a piece of material to which the substance will be applied. Of course, the material could also be manually placed within the device 802.

Preferred materials comprise amorphous regions and crystalline or semi-crystalline regions with one or more interface regions disposed therebetween. Contemplated materials include, for example, synthetic polymers, and could be in the form of fibers, threads, yarn, or even finished products such as shirts, pants, and so forth.

Device 802 includes one or more energy sources 804 that are configured to emit energy on to at least a portion of the material 806. The energy emitted by the energy source(s) could be, for example, heat, electromagnetic radiation, and infrared or near infrared radiation (e.g., between 750 nm-1400 nm). It is preferred that the energy emitted on to the material 806 is of an amount sufficient to render the interface region temporarily permeable such that a substance on a surface of the material can infiltrate into the interface region. More preferably, the amount of energy is within a Boson peak region of the material and preferably near the Boson peak for that material, which can be determined via known techniques that characterize parameters dependent on the number of degrees of freedom available to atoms or molecules within the material, such as those described above.

The substance preferably comprises one or more dyes, but could also include numerous other types of substances including, for example, a pharmaceutical, a polymer with advantageous properties, a metal, and so forth.

As the applied energy falls within the Boson peak region of the material 806, the interface region is rendered permeable due to the formation of one or more tunnels that allow the substance to infiltrate within the material beneath the material's surface. The substance can be drawn into the material via a driving force, which could include, for example, capillary action or a ripplon. Once within the material, the amount of energy will typically be reduced to an amount outside of the Boson peak region of the material, which causes the tunnels to collapse returning the material to its previous state.

Device 802 can further include a controller 808 that is configured to control the amount of energy emitted from energy source 804. In such embodiments, the controller 808 can be configured to automatically increase the amount of energy to fall within the Boson peak region of the material 806 and then reduce the energy applied after the substance infiltrates the material 806 in an amount desired by the operator.

It is further contemplated that the energy can be applied to the material 806 in a partial vacuum, which reduces the amount of energy required to cause the interface region to become permeable. This advantageously allows for a wider selection of materials to be used in the systems and methods described herein, including those materials that typically could not undergo prior art dyeing methods due to the high temperature required in the prior art processes. In other embodiments, a partial vacuum can be applied on only one of the sides of the material 806. When the interface region becomes permeable air can enter through the tunnels creating an air pocket within the material. Where the system is configured to allow for dyeing of both sides of a material, this advantageously allows for different colors of dye to be used with the air pocket helping to prevent mixture or bleeding of the dyes from opposite sides.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for infiltrating a substance into a heterogeneous solid, comprising;
providing a permeating substance and a heterogeneous solid, the heterogeneous solid comprising a first region, a second region, and an interface region interposed between the first region and the second region;
applying an energy to the heterogeneous solid, the energy of an amount sufficient to render the interface region temporarily permeable;
applying a driving force configured to infiltrate the permeating substance into the interface region; and,
modifying the application of the energy, thereby rendering the interface region impermeable.

2. The method of claim 1, wherein the first region comprises an amorphous solid and the second region comprises an at least semi-crystalline solid.

3. The method of claim 1, wherein the heterogeneous solid comprises a synthetic polymer.

4. The method of claim 4, wherein the heterogeneous solid comprises a fiber.

5. The method of claim 1, wherein the permeating substance comprises a dye.

6. The method of claim 1, wherein the energy comprises heat.

7. The method of claim 1, wherein the energy comprises electromagnetic radiation.

8. The method of claim 7, wherein the energy comprises infrared radiation.

9. The method of claim 1, wherein the amount of energy is within a Boson peak region of the heterogeneous solid.

10. The method of claim 9, wherein the driving force comprises capillary action.

11. The method of claim 9, wherein the driving force comprises a ripplon.

12. The method of claim 9, wherein the interface region is rendered permeable by the formation of one or more tunnels.

13. The method of claim 1, further comprising the step of applying at least a partial vacuum while the energy is applied.

14. A composite solid, comprising;
a heterogeneous solid comprising a first region, a second region, and an interface region interposed between the first region and the second region; and
a permeating substance lying within the interface region, wherein the permeating substance is introduced into the interface region by applying an energy configured to render the interface region temporarily permeable.

15. The composite solid of claim 14, wherein the first region comprises an amorphous solid and the second region comprises an at least semi-crystalline solid.

16. The composite solid of claim 15, wherein the energy is selected to lie within a Boson peak region of the heterogeneous solid.

17. The composite solid of claim 15, wherein the heterogeneous solid comprises a synthetic polymer.

18. The composite solid of claim 17, wherein the heterogeneous solid comprises a fiber.

19. The composite solid of claim 14, wherein the permeating substance comprises a dye.

20. The composite solid of claim 19, wherein the composite solid is resistant to chemical bleaching.
